(19) United States
(12) Patent Application Publication
(10) Pub. No.: US 2025/0320143 A1
(43) Pub. Date: Oct. 16, 2025

(54) RAW WATER TREATMENT METHOD AND RAW WATER TREATMENT DEVICE

(71) Applicant: ORGANO CORPORATION, Tokyo (JP)

(72) Inventors: Shohei MIZUMA, Tokyo (JP); Hironori YUI, Tokyo (JP); Taichi YAMAMOTO, Tokyo (JP)

(73) Assignee: ORGANO CORPORATION, Tokyo (JP)

(21) Appl. No.: 18/871,321

(22) PCT Filed: Apr. 26, 2023
(86) PCT No.: PCT/JP2023/016543

§ 371 Date: Dec. 3, 2024

(30) Foreign Application Priority Data
Jun. 9, 2022 (JP) 2022-093960

(51) Int. Cl. C02F 3/12; C02F 1/44

(52) U.S. Cl. CPC C02F 3/12; C02F 1/44; C02F 2209/40; C02F 2301/043

(57) ABSTRACT

A raw water treatment method includes: treating raw water using a raw water treatment device provided with a biological treatment tank that contains a carrier holding an aerobic microorganism, and a membrane separation active sludge treatment unit provided with an active sludge treatment tank into which first treated water biologically treated in the biological treatment tank flows, and which stores active sludge, and a membrane separation device that subjects second treated water biologically treated in the active sludge treatment tank to membrane treatment; and causing a portion of the raw water to flow into the active sludge treatment tank while bypassing the biological treatment tank.

### TECHNICAL FIELD

The present invention relates to a raw water treatment method and a raw water treatment device.

### BACKGROUND

One known technique for treating organic wastewater is a technique that combines a biological treatment using a carrier (hereinafter sometimes referred to as a “carrier method”) and a membrane separation activated sludge treatment (hereinafter sometimes referred to as an “MBR treatment”). This technique offers the two advantages of enabling high-speed treatment as a result of using the carrier method, while also yielding clean treated water as a result of the MBR treatment.

For example, Patent Document 1 discloses a technique for treating an organic wastewater in which two or more biological treatment tanks are arranged in series, but if the amount of sludge generated in the latter-stage biological treatment tank is reduced, then it is claimed that because the reduction in the BOD volume load is accompanied by elution of nitrogen contained in the sludge into the treated water, and a residual nitrogen fraction not used in microorganism synthesis is also present, a problem arises in that when wastewater containing a large amount of nitrogen is treated, the nitrogen wastewater standard is exceeded. For this type of case, a method has been proposed in which a separate oxygen-free tank is provided to conduct a denitrification treatment, thereby reducing the nitrogen fraction, but this requires a large installation space, and makes the treatment system more complex. Further, the amount of phosphorus, which, like nitrogen, is a concern when retained in the treated water, cannot be reduced.

Further, for example, Patent Documents 2 and 3 disclose techniques in which a portion of the organic wastewater is made to bypass the early-stage biological treatment tank and supplied to the latter-stage MBR treatment tank. The techniques in Patent Documents 2 and 3 include a step of measuring the wastewater load of the early-stage biological treatment tank and automatically controlling the amount of bypassed wastewater, but these types of methods are unable to adapt to deterioration in the treated water that can accompany changes in the reaction filed such as changes in the sludge properties, and in some cases, may be unable to suppress the elution of nitrogen and phosphorus. Further, because the substances targeted for removal from the organic wastewater are measured on-line, in those cases where the solid fraction in the organic wastewater is large, the stability of the measurements generally deteriorates and satisfactory precision is unattainable, making it difficult to achieve appropriate operational control. Moreover, as mentioned in Patent Document 4, when the measurement target is wastewater with a comparatively high concentration, maintenance and configuration of the sensors requires considerable effort, which can result in an increased operational management load.

### CITATION LIST

### Patent Literature

Patent Document 1: JP 4892917 B
Patent Document 2: JP 5575316 B
Patent Document 3: JP 5922406 B
Patent Document 4: JP 2021-159845 A

### SUMMARY

### Technical Problem

An object of the present invention is to suppress the elution of nitrogen and phosphorus into the treated water in a raw water treatment that combines a biological treatment using a carrier and a membrane separation activated sludge treatment.

### Solution to Problem

A raw water treatment method of the present invention has a raw water treatment step of treating raw water using a raw water treatment device provided with a biological treatment tank containing a carrier supporting an aerobic microorganism, and a membrane separation activated sludge treatment unit that includes an activated sludge treatment tank containing an activated sludge into which first treated water that has undergone biological treatment in the biological treatment tank flows, and a membrane separation device that subjects second treated water that has undergone biological treatment in the activated sludge treatment tank to a membrane treatment; and an inflow step of causing a portion of the raw water to bypass the biological treatment tank and flow into the activated sludge treatment tank, wherein in the inflow step, the flow rate of the raw water bypassing the biological treatment tank and flowing into the activated sludge treatment tank is controlled based on the nitrogen concentration and the phosphorus concentration in third treated water that has undergone treatment in the membrane separation device.

Further, the above raw water treatment method preferably also has a nitrogen source-phosphorus source addition step of adding a nitrogen source and/or a phosphorus source to the biological treatment tank, wherein in the addition step, the amount added of the nitrogen source and/or the phosphorus source is controlled based on the flow rate of the raw water bypassing the biological treatment tank.

Furthermore, the above raw water treatment method preferably also has an inorganic coagulant addition step of adding an inorganic coagulant to the activated sludge treatment tank in those cases where the phosphorus concentration in the third treated water that has undergone treatment in the membrane separation device equals or exceeds a prescribed value.

Furthermore, the present invention also provides a raw water treatment device for treating raw water, having a biological treatment tank containing a carrier supporting an aerobic microorganism, a membrane separation activated sludge treatment unit that includes an activated sludge treatment tank containing an activated sludge into which first treated water that has undergone biological treatment in the biological treatment tank flows, and a membrane separation device that subjects second treated water that has undergone biological treatment in the activated sludge treatment tank to a membrane treatment, a bypass line that causes a portion of the raw water to bypass the biological treatment tank and flow into the activated sludge treatment tank, and a control unit for controlling the flow rate of the raw water flowing through the bypass line based on the nitrogen concentration and the phosphorus concentration in third treated water that has undergone treatment in the membrane separation device.

Further, the above raw water treatment device preferably also has a nitrogen source-phosphorus source addition unit for adding a nitrogen source and/or a phosphorus source to the biological treatment tank, wherein the nitrogen source-phosphorus source addition unit controls the amount added of the nitrogen source and/or the phosphorus source based on the flow rate of the raw water flowing through the bypass line.

Furthermore, the above raw water treatment device preferably also has an inorganic coagulant addition unit for adding an inorganic coagulant to the activated sludge treatment tank, wherein the inorganic coagulant addition unit adds the inorganic coagulant to the activated sludge treatment tank in those cases where the phosphorus concentration in the third treated water that has undergone treatment in the membrane separation device equals or exceeds a prescribed value.

### Advantageous Effects of Invention

By employing the present invention, the elution of nitrogen and phosphorus into the treated water can be suppressed in a raw water treatment that combines a biological treatment using a carrier and a membrane separation activated sludge treatment.

### BRIEF DESCRIPTION OF DRAWINGS

FIG. 1 is a schematic diagram illustrating one example of the structure of a raw water treatment device according to an embodiment of the present invention.

FIG. 2 is a graph illustrating the changes over time in a ratio of the raw water bypassed into the activated sludge treatment tank relative to the raw water flow rate and the soluble BOD sludge load in an example.

FIG. 3 is a graph illustrating the changes over time in the total nitrogen concentration (TN concentration) and the phosphate-phosphorus concentration (PO₄—P concentration) of the treated water that has undergone treatment in the membrane separation device in an example.

FIG. 4 is a graph illustrating the relationship between the soluble BOD sludge load of the activated sludge treatment tank and the TN concentration of the treated water in a comparative example and reference examples 1 and 2.

FIG. 5 is a graph illustrating the relationship between the soluble BOD sludge load of the activated sludge treatment tank and the PO₄—P concentration of the treated water in a comparative example and reference examples 1 and 2.

### DESCRIPTION OF EMBODIMENTS

Embodiments of the present invention will be described below. These embodiments are merely examples of implementing the present invention, and the present invention is not limited to these embodiments.

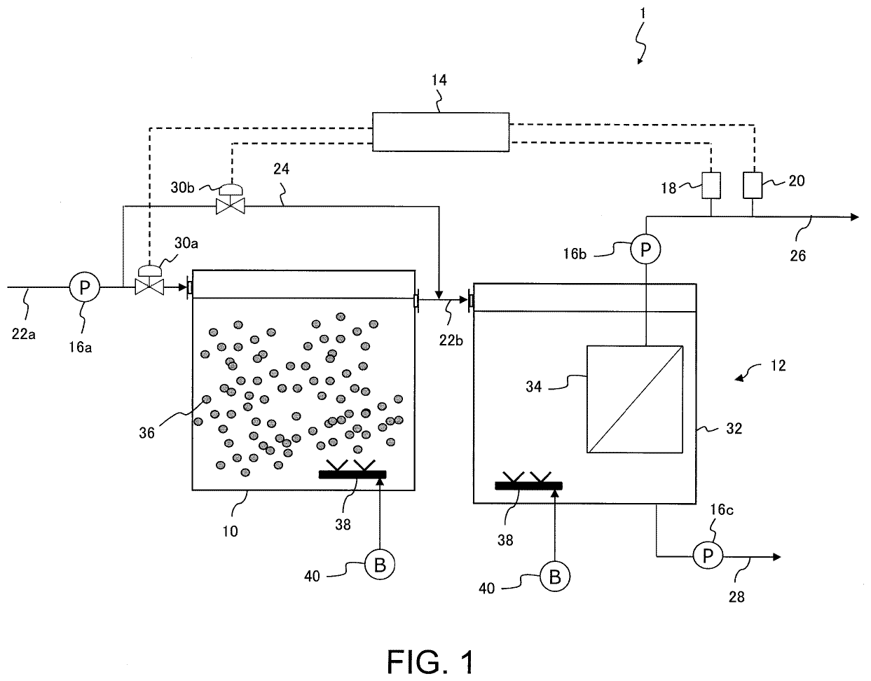

FIG. 1 is a schematic diagram illustrating one example of the structure of a raw water treatment device according to an embodiment of the present invention. The raw water treatment device 1 is provided with a biological treatment tank 10, a membrane separation activated sludge treatment unit 12, a control device 14, pumps (16a, 16b and 16c), a nitrogen concentration detector 18, a phosphorus concentration detector 20, inflow lines (22a and 22b), a bypass line 24, a treated water discharge line 26, a sludge discharge line 28, and flow rate adjustment valves (30a and 30b). The membrane separation activated sludge treatment unit 12 includes an activated sludge treatment tank 32 and a membrane separation device 34. The membrane separation device 34 is, for example, a separation membrane module or the like provided with a separation membrane. In the raw water treatment device 1 of FIG. 1, the membrane separation device 34 is housed inside the activated sludge treatment tank 32.

The inflow line 22a is connected to the biological treatment tank 10. Further, the pump 16a and the flow rate adjustment valve 30a are installed in the inflow line 22a. One end of the inflow line 22b is connected to the biological treatment tank 10, and the other end of the inflow line 22b is connected to the activated sludge treatment tank 32. One end of the bypass line 24 is connected to the inflow line 22a, and the other end of the bypass line 24 is connected to the inflow line 22b. Further, the flow rate adjustment valve 30b is installed in the bypass line 24. The treated water discharge line 26 is connected to a treated water outlet in the membrane separation device 34. Further, the pump 16b, the nitrogen concentration detector 18 and the phosphorus concentration detector 20 are installed in the treated water discharge line 26. The sludge discharge line 28 is connected to the activated sludge treatment tank 32. Further, the pump 16c is installed in the sludge discharge line 28. The control device 14 and the flow rate adjustment valves (30a and 30b), and the control device 14 and the nitrogen concentration detector 18 and phosphorus concentration detector 20 are, for example, connected electrically.

The inside of the biological treatment tank 10 is filled with a carrier 36 that supports an aerobic microorganism. The microorganism supported on the carrier 36 is a microorganism which, under aerobic conditions, is capable of decomposing organic matter in the raw water flowing into the biological treatment tank 10. An activated sludge is housed inside the activated sludge treatment tank 32. The activated sludge is a sludge containing a microorganism which, under aerobic conditions, is capable of decomposing organic matter in the treated water and raw water flowing into the activated sludge treatment tank 32.

An aeration device 38 is provided in the bottom inside each of the biological treatment tank 10 and the activated sludge treatment tank 32. For example, a blower 40 is connected to each of the aeration devices 38, so that air supplied from the blower 40 is able to be supplied from the aeration device 38 into the inside of the biological treatment tank 10 or the inside of the activated sludge treatment tank 32.

The nitrogen concentration detector 18 may be any device capable of detecting the nitrogen concentration in the treated water, and examples of the detector include a total nitrogen concentration meter (TN meter) or an ammonia concentration meter. The phosphorus concentration detector 20 may be any device capable of detecting the phosphorus concentration in the treated water, and examples of the detector include a total phosphorus concentration meter (TP meter) or a phosphate concentration meter.

The control device 14 is, for example, composed of a microcomputer comprising a CPU that executes programs and ROM and RAM that store programs and operational results, and electrical circuits and the like, and the control device 14 reads a prescribed program stored in ROM or the like, and executes that program to control the operation of the raw water treatment device 1. For example, based on the nitrogen concentration and/or phosphorus concentration in the treated water, the control device 14 may control the degrees of opening of the flow rate adjustment valves 30a and 30b, thereby controlling the amount of raw water flowing through the bypass line 24. Further, that control device 14 may, for example, also be configured to control the operation of the pumps 16 and the blowers 40.

In addition, in order to ascertain the flow rate of the raw water flowing through the bypass line 24, flow rate measurement devices may also be installed in the inflow line 22a and the bypass line 24. Further, in order to confirm the water quality of the treated water, a total organic carbon meter (TOC meter) may also be installed in the treated water discharge line 26.

Next is a description of one example of the operation of the raw water treatment device 1 according to an embodiment of the present invention.

The control device 14 operates the pump 16a and opens the flow rate adjustment valve 30a to a prescribed degree of opening, thereby supplying the raw water from the inflow line 22a to the biological treatment tank 10. At this time, the control device 14 may also open the flow rate adjustment valve 30b to a prescribed degree of opening, thereby causing a portion of the raw water passing through the inflow line 22a to bypass through the bypass line 24 and into the activated sludge treatment tank 32.

The control device 14 operates the blower 40, thereby supplying air from the aeration device 38 into the biological treatment tank 10. Then, inside the biological treatment tank 10, organic matter within the raw water is biologically treated under aerobic conditions by the microorganism supported on the carrier 36. The treated water that has undergone treatment in the biological treatment tank 10 (first treated water) passes through the inflow line 22b and flows into the activated sludge treatment tank 32.

Further, the control device 14 also operates the blower 40 and supplies air from the aeration device 38 into the activated sludge treatment tank 32. Then, inside the activated sludge treatment tank 32, organic matter within the first treated water that has flowed in from the inflow line 22b and the bypassed raw water that has flowed in from the bypass line 24 is biologically treated under aerobic conditions by the activated sludge. Furthermore, the control device 14 also operates the pump 16b, thereby passing the treated water that has been biologically treated inside the activated sludge treatment tank 32 (second treated water) through the membrane separation device 34, removing the sludge from the second treated water, and discharging the treated water that has passed through the separation membrane of the membrane separation device 34 (third treated water: a filtrate from which the sludge has been removed) through the treated water discharge line 26 and outside of the system. Furthermore, the control device 14 also operates the pump 16c, thereby discharging the sludge that has accumulated in the activated sludge treatment tank 32 through the sludge discharge line 28 and outside of the system.

Next is a description of an example of controlling the flow rate of the bypassed raw water into the activated sludge treatment tank 32. First, the nitrogen concentration and phosphorus concentration in the third treated water detected by the nitrogen concentration detector 18 and the phosphorus concentration detector 20 respectively are input into the control device 14. Then, in the case where at least one of the input nitrogen concentration and phosphorus concentration equals or exceeds a preset prescribed value (different prescribed values may be set for the nitrogen concentration and the phosphorus concentration, or the same prescribed value may be used), the degrees of opening of the flow rate adjustment valves 30a and 30b are controlled so that the flow rate of the raw water flowing through the bypass line 24 increases. For example, if no raw water is flowing through the bypass line 24, the degrees of opening of the flow rate adjustment valves 30a and 30b are controlled so that raw water at a prescribed flow rate flows through the bypass line 24. Further, in those cases where, for example, raw water is already flowing through the bypass line 24, the degrees of opening of the flow rate adjustment valves 30a and 30b are controlled so that raw water with a flow rate exceeding the current raw water flow rate by a prescribed proportion flows through the bypass line 24. In those cases where, as a result of continued operation with an increased flow rate of the raw water through the bypass line 24, the nitrogen concentration and phosphorus concentration in the treated water detected by the nitrogen concentration detector 18 and the phosphorus concentration detector 20 respectively fall to values less than the preset prescribed value, the control device 14 preferably controls the degrees of opening of the flow rate adjustment valves 30a and 30b so that the flow rate of raw water flowing through the bypass line 24 decreases. For example, the degrees of opening of the flow rate adjustment valves 30a and 30b may be controlled so that inflow of the raw water into the bypass line 24 is halted. Alternatively, for example, the degrees of opening of the flow rate adjustment valves 30a and 30b may be controlled so that raw water with a flow rate reduced from the current raw water flow rate through the bypass line 24 by a prescribed proportion flows through the bypass line 24. In order to ensure stable treatment, the preset prescribed value is preferably within a range from 0.6 to 1 times the treatment target value. Further, in order to ensure treatment stability in the biological treatment tank, the upper limit for the flow rate of raw water through the bypass line 24 is preferably 90% of the raw water flow rate.

Because the treatment in the latter-stage activated sludge treatment tank 32 typically proceeds faster than that in the early stage biological treatment tank 10, the BOD volume load of the later-stage activated sludge treatment tank 32 is invariably low. In such cases, the water quality of the treated water may sometimes deteriorate due to elution of nitrogen and phosphorus from the microorganisms such as the activated sludge, and residual nitrogen and phosphorus not used in the microorganism synthesis. However, in the present embodiment, because the flow rate of bypassed raw water into the activated sludge treatment tank 32 is controlled based on the nitrogen concentration and phosphorus concentration of the treated water in the manner described above, the BOD volume load of the activated sludge treatment tank 32 can be prevented from falling too low. As a result, the elution of excess nitrogen and phosphorus from the microorganisms of the activated sludge inside the activated sludge treatment tank 32 is suppressed, meaning the flow of nitrogen and phosphorus into the treated water can be suppressed.

Various configurations and treatment conditions and the like for the raw water treatment device 1 according to an embodiment of the present invention will be described below in further detail.

The raw water that represents the treatment target is organic wastewater or the like discharged, for example, from a sewage treatment, food processing plant, chemical plant, semiconductor plant or liquid crystal plant, paper pulp plant, or plant in some other field, and may be any raw water to which a biological treatment can be applied.

In terms of better suppressing the elution of nitrogen and phosphorus into the treated water, the BOD volume loads for both the biological treatment tank 10 and the activated sludge treatment tank 32 are, for example, preferably at least 0.5 kgBOD/(m³·d), more preferably at least 1.0 kgBOD/(m³·d), and even more preferably 1.5 kgBOD/(m³·d) or greater. If consideration is given to residual organic matter within the treated water and the elution of nitrogen and phosphorus, then the upper limit for the BOD volume loads is preferably not more than 6 kgBOD/(m³·d).

In terms of better suppressing the elution of nitrogen and phosphorus into the treated water, the BOD volume load for the activated sludge treatment tank 32 is, for example, preferably within a range from 0.005 to 0.15 kgBOD/(kgMLSS·d).

The sludge residence time (SRT) for the activated sludge treatment tank 32 varies depending on the volume load, but is, for example, preferably within a range from 5 to 50 days, and more preferably within a range from 20 to 40 days. If the SRT is too long, then in some cases, self-oxidation of microorganisms in the sludge may occur, polymeric matter that does not pass through the separation membrane may accumulate inside the activated sludge treatment tank 32, and blockages of the membrane may occur. Furthermore, if the SRT is too short, then the sludge may adopt a dispersed state, and blockages of the separation membrane may sometimes occur.

There are no particular limitations on the pH values inside the biological treatment tank 10 and inside the activated sludge treatment tank 32, provided the pH is within the range suitable for typical biological treatments, and for example, a pH within a range from 6 to 9 is preferred, and a pH within a range from 6.5 to 7.5 is more preferred. Adjustment of the pH of the water inside the biological treatment tank 10 or the activated sludge treatment tank 32 may be made by adding a pH modifier to the tank. Examples of the pH modifier include acidic agents such as hydrochloric acid, and alkali agents such as sodium hydroxide.

There are no particular limitations on the amount of dissolved oxygen (DO) inside the biological treatment tank 10 and the activated sludge treatment tank 32, provided the amount provides sufficient oxygen for typical biological treatments, and for example, dissolved oxygen of at least 0.5 mg/L is preferred, and 1 mg/L or greater is more preferred.

There are no particular limitations on the water temperature inside the biological treatment tank 10 and the activated sludge treatment tank 32, provided the temperature is within the range suitable for typical biological treatments, and for example, a temperature within a range from 15 to 35° C. is preferred, and a temperature within a range from 20 to 30° C. is more preferred.

A nitrogen source and/or a phosphorus source is preferably added to the biological treatment tank 10 as a nutrient. When a nitrogen source and/or phosphorus source is added to the biological treatment tank 10, the amount of the nitrogen source and/or phosphorus source added is preferably controlled based on the flow rate of raw water through the bypass line 24. One example of a control method is described below. A nitrogen source supply line fitted with a first pump and a phosphorus source supply line fitted with a second pump are installed on the biological treatment tank 10. Further, a flow rate meter for detecting the amount of inflow of the raw water per unit time is installed in the bypass line 24. Then, the amount of inflow of the raw water per unit time detected by the flow rate meter is input into the control device 14, and in those cases where the amount of inflow is equal to or lower than a prescribed value, the control device 14 operates the first pump and the second pump, and supplies the nitrogen source from the nitrogen source supply line and the phosphorus source from the phosphorus source supply line to the biological treatment tank 10. Then, when the amount of inflow exceeds the prescribed value, the control device 14 halts operation of the first pump and the second pump, stopping supply of the nitrogen source and the phosphorus source. For example, the control device 14 may fit the amount of inflow per unit time detected by the flow rate meter to a map (or formula or table or the like) of predetermined values for the amount of inflow per unit time and the amount added of the nitrogen source, and a map (or formula or table or the like) of predetermined values for the amount of inflow per unit time and the amount added of the phosphorus source, thereby determining the amounts of the nitrogen source and the phosphorus source to be added, and then control the output of the first pump and the second pump so that the determined amounts of the nitrogen source and the phosphorus source are supplied. The above maps prescribe that if the amount of inflow increases, the added amounts of the nitrogen source and the phosphorus source decrease, whereas if the amount of inflow decreases, the added amounts of the nitrogen source and the phosphorus source increase.

There are no particular limitations on the nitrogen source, and examples include ammonium chloride, ammonium sulfate, diammonium hydrogen phosphate, and urea. There are no particular limitations on the phosphorus source, and examples include phosphoric acid, sodium phosphate, and potassium phosphate. Besides the nitrogen source and the phosphorus source, inorganic salts or the like of iron, manganese and/or calcium or the like may also be supplied to the biological treatment tank 10 as nutrients. A nitrogen source and phosphorus source are preferably not added to the activated sludge treatment tank 32.

The carrier 36 inside the biological treatment tank 10 may be any conventional carrier, and examples include plastic carriers, sponge-like carriers, and gel-like carriers. Among these, in terms of cost and durability, sponge-like carriers are preferred, and for example, polyurethane sponge-like carriers are preferred. The carrier 36 is not limited to fluid type carriers that flow through the inside of the biological treatment tank 10, and may also be a solid carrier that is installed inside the biological treatment tank 10 such as a cartridge or the like filled with the carrier 36. There are no particular limitations on the shape of the carrier 36, and examples include rectangular shapes such as cubes, as well as granules, spheres, pellets, cylinders, fibers and films. The amount of the carrier 36 introduced into the biological treatment tank 10 is preferably within a range from 10 to 70% of the tank volume. The carrier 36 may also be added to the activated sludge treatment tank 32.

The membrane separation device 34 of an embodiment of the present embodiment is exemplified by the immersed membrane separation device 34 installed inside the activated sludge treatment tank 32, but the present invention is not limited to this configuration, and a tank-like membrane separation device 34 may also be installed outside the activated sludge treatment tank 32. Of these options, from the viewpoints of the installation surface area and operating power required for the device, use of an immersed membrane separation device 34 is desirable.

Examples of the shape of the separation membrane installed in the membrane separation device 34 include flat, hollow fiber, tubular and spiral membranes. Examples of the material of the immersed membrane include organic membranes such as polyethylene (PE), polyvinylidene fluoride (PVDF), polytetrafluoroethylene (PTFE), polyvinyl chloride (PVC), polyethersulfone (PES) and cellulose acetate (CA), and inorganic membranes made of ceramics. The pore size of the separation membrane is, for example, preferably not more than 1.0 μm, and a precision filtration membrane or ultrafiltration membrane with a pore size of 0.1 μm or less is preferred. The permeation rate for the separation membrane is preferably operated within a range from about 0.1 to 0.8 m/day, and operation at a rate within a range from 0.2 to 0.6 m/day is particularly preferred.

An inorganic coagulant is preferably added to the activated sludge treatment tank 32 when the phosphorus concentration in the treated water that has been treated in the membrane separation device 34 equals or exceeds a preset prescribed value. For example, an inorganic coagulant supply line fitted with a pump may be installed on the activated sludge treatment tank 32. Then, when the phosphorus concentration input from the phosphorus concentration detector 20 equals or exceeds the preset prescribed value, the control device 14 operates the pump, thereby supplying the inorganic coagulant from the inorganic coagulant supply line to the activated sludge treatment tank 32. By employing this type of operation, the phosphorus concentration in the treated water can be reduced rapidly. Conventional substances may be used as the inorganic coagulant, and examples include polyaluminum chloride (PAC) and ferric chloride. The amount added of the inorganic coagulant is preferably at least as large as the theoretically required amount. The theoretically required amount in the case of PAC (assuming Al₂O₃=10.5 wt %) is 15.7 mg/L per 1 mg/L of phosphorus concentration, and in the case of ferric chloride (assuming FeCl₃=38 wt %) is 13.8 mg/L per 1 mg/L of phosphorus concentration.

### EXAMPLES

The present invention will be described below in more specific detail using an example and a comparative example, but the present invention is not limited to the following examples.

### EXAMPLE

Using the raw water treatment device illustrated in FIG. 1, simulated wastewater (raw water) was subjected to a continuous water flow test. However, a control device was not used, and control of the opening and closing of the flow rate adjustment valves and operational control of the pumps were performed manually. Further, a breeding step was provided prior to starting the continuous water flow test. Specifically, raw water was passed only through the biological treatment tank, and the BOD volume load was increased while measuring the BOD concentration of the treated water, thereby ensuring satisfactory adherence of microorganisms to the carrier. The continuous water flow test was then started using a combination of the biological treatment tank that had undergone this breeding step and the membrane separation activated sludge treatment unit. An activated sludge bred in the raw water was added to the activated sludge treatment tank.

### <Continuous Water Flow Test Conditions>

Biological treatment tank volume: 12 L
Biological treatment tank carrier: hydrophobic polyurethane sponge carrier
Biological treatment tank carrier fill rate: 20% by bulk volume
Separation membrane of membrane separation device: PVDF hollow fiber membrane
Filtration flux of membrane separation device: 0.4 m/d
   Filtration flux indicates the amount of treated water per unit of surface area of the separation membrane, and was calculated in the following manner. Filtration flux=raw water flow rate=membrane surface area of separation membrane
Activated sludge treatment tank volume: 24 L
Activated sludge treatment tank sludge concentration (MLSS): 8,000 mg/L
Activated sludge treatment tank sludge extraction: sludge extracted once per day to achieve MLSS of 8,000 mg/L
Raw water BOD concentration representative value: 500, 1,000, 1,500 mg/L (in comparative example and reference examples 1 and 2 below: 1,000 mg/L)
Substrates in raw water: sucrose, sodium acetate, propionic acid, 2-propanol Nitrogen and phosphorus in raw water: ammonium chloride and phosphoric acid used to adjust BOD:N:P=100:5:1
Other necessary trace elements: trace element solution added to raw water
Raw water SS: none
Raw water flow rate: 54 L/d (with appropriate level of bypass to activated sludge treatment tank)
Total BOD volume load: 1.5 kgBOD/(m³·d).
   Total BOD volume load was calculated in the following manner. Total BOD volume load=raw water BOD concentration×inflow rate÷total tank volume of biological treatment tank and activated sludge treatment tank

In all test periods, the soluble BOD removal rate for the biological treatment tank was 95% or higher, and at least 95% of the ammoniacal nitrogen concentration and phosphate-phosphorus concentration was able to be removed. The soluble BOD removal rate for the biological treatment tank was calculated in the following manner.

Biological treatment tank soluble BOD removal rate=(raw water BOD concentration−biological treatment tank soluble BOD concentration)÷raw water BOD concentration

Because the raw water contains no SS, raw water BOD=soluble BOD. The biological treatment tank soluble BOD concentration represents the BOD concentration following filtration through a 0.45 μm filter to remove suspended components.

The various values described in the example (and the comparative example and reference examples described below) were calculated in the following manner.
(1) Soluble BOD sludge load of activated sludge treatment tank=((biological treatment tank soluble BOD concentration×raw water flow rate into biological treatment tank)+(raw water bypass flow rate into activated sludge treatment tank×raw water soluble BOD concentration)÷(sludge concentration inside tank×tank volume)

Because the raw water contains no SS, raw water BOD=soluble BOD.
(2) Sludge residence time in activated sludge treatment tank=(sludge concentration in tank×tank volume)÷(extracted sludge concentration×amount of extracted water)
(3) BOD sludge conversion rate=amount of sludge generated in activated sludge treatment tank÷total BOD removal
(4) Amount of sludge generated in activated sludge treatment tank=((sludge concentration in activated sludge treatment tank after prescribed time period−initial sludge concentration in activated sludge treatment tank)×activated sludge treatment tank volume)+(extracted sludge concentration×amount of extracted water)
(5) Total BOD removal=(raw water BOD concentration-BOD concentration of membrane separation treated water in activated sludge treatment tank)×raw water flow rate
(6) The suction pressure represents a value measured by a pressure meter (model GC67, manufactured by Nagano Keiki Co., Ltd.) installed in the treated water discharge line. The suction pressure was logged, and recorded as the increase in suction pressure per day across a prescribed period.

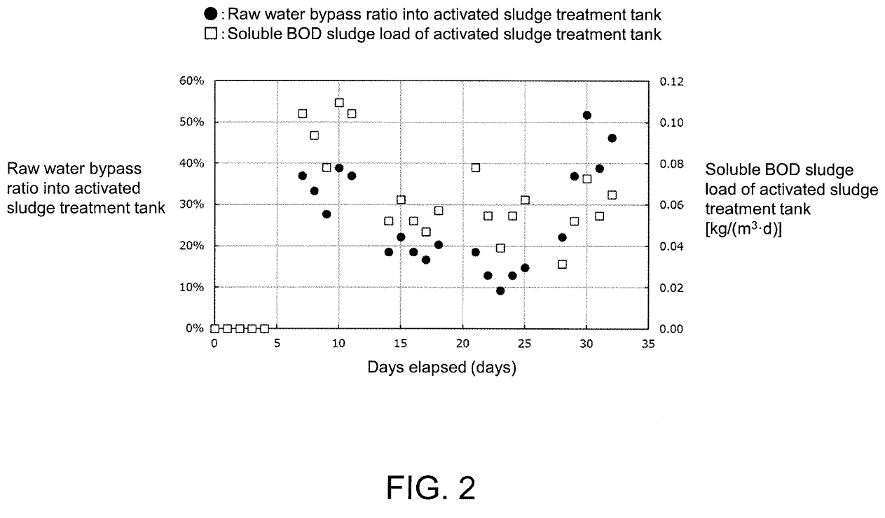

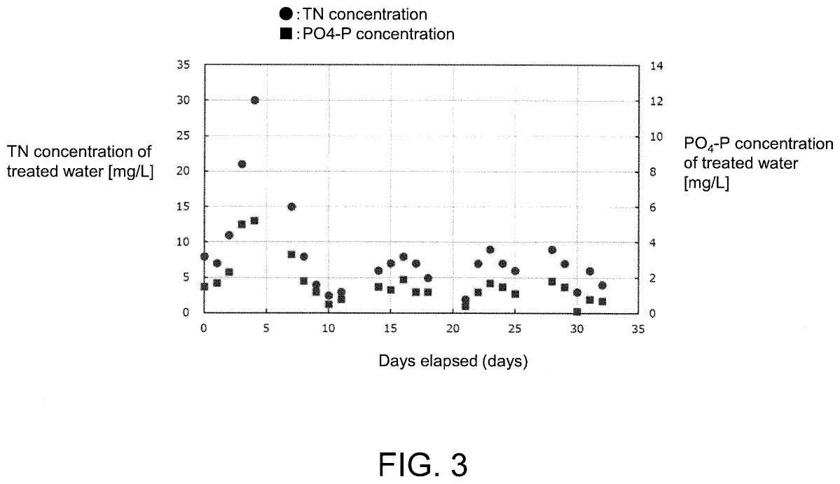

FIG. 2 illustrates the changes over time in the raw water bypass ratio into the activated sludge treatment tank relative to the raw water flow rate and the soluble BOD sludge load in the example. Further, FIG. 3 illustrates the changes over time in the total nitrogen concentration (TN concentration) and the phosphate-phosphorus concentration (PO₄—P concentration) of the treated water that has undergone treatment in the membrane separation device in the example. In the example, for the first five days, the water flow test was conducted without any bypass inflow of the raw water into the activated sludge treatment tank. Then, once increases in the nitrogen concentration and phosphorus concentration had been confirmed in the treated water that had undergone treatment in the membrane separation device, bypass inflow of the raw water into the activated sludge treatment tank was started. From the start of water flow until the day 18, the raw water BOD concentration was set to 1,000 mg/L, from day 19 until the day 25, the raw water BOD concentration was increased to 1,500 mg/L, and thereafter the raw water BOD concentration was set to 500 mg/L. The target values in this test were 10 mg/L or less for the TN concentration, and 2 mg/L or less for the PO₄—P concentration.

As illustrated in FIG. 3, during the period where no bypass inflow of the raw water into the activated sludge treatment tank was conducted, the TN concentration and the PO₄—P concentration of the treated water that had undergone treatment by the membrane separation device (hereinafter, simply referred to as “the treated water”) increased, and exceeded the target values. Because the TN concentration and the PO₄—P concentration of the treated water had exceeded the respective target values, in the period from day 7 to day 11, bypass inflow of the raw water into the activated sludge treatment tank was conducted with the bypass ratio of raw water into the activated sludge treatment tank set to 28 to 39%, enabling the TN concentration and the PO₄—P concentration of the treated water to be reduced to the respective target values. Further, the soluble BOD sludge load for the activated sludge treatment tank varied from 0.08 to 0.1 kgBOD/(kgMLSS·d). In the period from day 14 to day 18, operations were continued with the raw water bypass ratio into the activated sludge treatment tank reduced to 17 to 22%, and although the TN concentration and the PO₄—P concentration of the treated water increased, the target values were still able to be maintained. The soluble BOD sludge load for the activated sludge treatment tank during this period varied from 0.05 to 0.06 kgBOD/(kgMLSS·d). Based on these results, it is evident that by controlling the flow rate of the raw water bypassing the biological treatment tank and flowing into the activated sludge treatment tank based on the TN concentration and the PO₄—P concentration of the treated water, elution of nitrogen and phosphorus into the treated water can be suppressed, and operations can be managed so as to achieve favorable treated water quality. Further, by increasing the raw water bypass ratio, even more favorable treated water quality can be achieved.

From day 19 onward, operations were conducted while the raw water BOD concentration was varied, but even with fluctuations in the raw water concentration, by controlling the flow rate of the raw water bypassed into the activated sludge treatment tank (namely, the raw water bypass ratio into the activated sludge treatment tank) in accordance with the TN concentration and the PO₄—P concentration of the treated water, elution of nitrogen and phosphorus into the treated water can be suppressed, and operations can be managed so as to achieve favorable treated water quality. The soluble BOD sludge load into the activated sludge treatment tank during the entire test period varied from 0.03 to 0.11 kgBOD/(kgMLSS·d).

### Comparative Example and Reference Examples 1 and 2

In the comparative example, testing was conducted in the same manner as in the example, with the exception of having no bypass inflow of the raw water into the activated sludge treatment tank. Further, in the reference examples 1 and 2, although bypass inflow of the raw water into the activated sludge treatment tank was conducted, the raw water bypass ratio was not controlled in accordance with the TN concentration and the PO₄—P concentration of the treated water, but rather, the raw water bypass ratio was simply increased. With this exception, testing was conducted in the same manner as in the example. The reference examples 1 and 2 were conducted under the same conditions with the exception of a different sludge residence time in the activated sludge treatment tank. The sludge residence time in the activated sludge treatment tank was set to 30 days in reference example 1, and to 40 days in reference example 2.

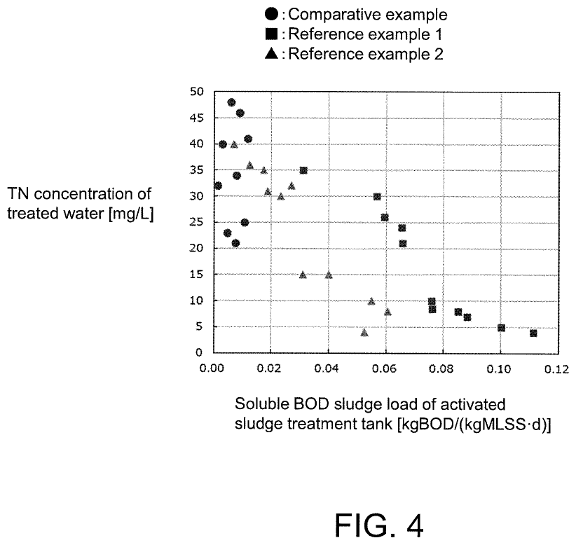

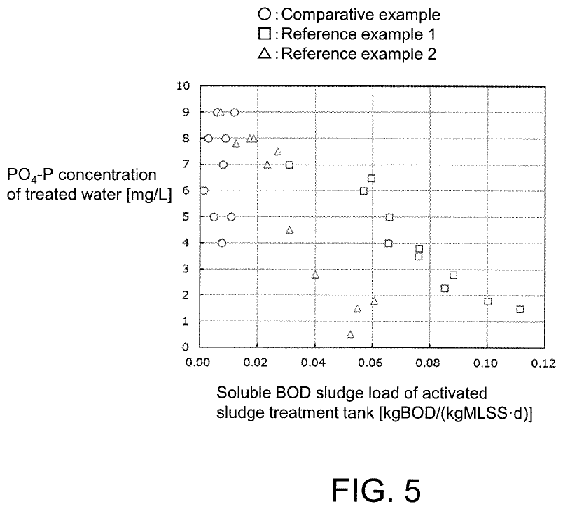

FIG. 4 illustrates the relationship between the soluble BOD sludge load of the activated sludge treatment tank and the TN concentration of the treated water in the comparative example and reference examples 1 and 2. FIG. 5 illustrates the relationship between the soluble BOD sludge load of the activated sludge treatment tank and the PO₄—P concentration of the treated water in the comparative example and reference examples 1 and 2. In the comparative example, the soluble BOD sludge load of the activated sludge treatment tank was less than 0.02 kgBOD/(kgMLSS·d), and the treated water had a TN concentration that fluctuated at values of 20 mg/L or higher, and a PO₄—P concentration that fluctuated at values of 4 mg/L or higher. It is thought that, in the comparative example, because there was no bypass inflow of the raw water into the activated sludge treatment tank, the soluble BOD sludge load was low, as mentioned above, and disintegration of the sludge inside the activated sludge treatment tank tended to proceed, resulting in the elution of nitrogen and phosphorus into the treated water. In the reference examples 1 and 2, by increasing the raw water bypass ratio and conducting operations with an increased soluble BOD sludge load in the activated sludge treatment tank, the TN concentration and PO₄—P concentration of the treated water were both able to satisfy the respective target values. However, the soluble BOD sludge load required to ensure the TN concentration and PO₄—P concentration satisfied the target values was at least 0.1 kgBOD/(kgMLSS·d) in reference example 1, and at least 0.05 kgBOD/(kgMLSS·d) in reference example 2, with a different numerical range in each reference example. Consequently, in order to conduct control using the soluble BOD sludge load, the numerical range required to achieve the target water quality must be ascertained either in advance or during operation. However, it is thought that that numerical range will vary depending on the operating conditions, meaning conducting control using the soluble BOD sludge load during operation is likely to be difficult.

Table 1 illustrates the suction pressure increase per day for the separation membrane, the sludge residence time in the activated sludge treatment tank, and the BOD sludge conversion rate during the operation period in the example, the comparative example, and the reference examples 1 and 2.

TABLE 1

| | Suction pressure | | BOD sludge |
|---|---|---|---|
| | increase | Sludge residence | conversion |
| | per day | time | Rate |
| | (kPa/d) | (days) | (gMLSS/gBOD) |
| Comparative | 1.5 | 60 | 0.15 |
| example | | | |
| Reference | 0.4 | 30 | 0.25 |
| example 1 | | | |
| Reference | 0.5 | 40 | 0.21 |
| example 2 | | | |
| Example | 0.3 | 30 | 0.23 |

The comparative example which did not employ bypass inflow of the raw water into the activated sludge treatment tank had a low BOD sludge conversion rate compared with the example and the like in which bypass of the raw water was performed. This is because by not implementing bypass of the raw water, the organic matter load of the activated sludge treatment tank is lowered, leading to disintegration of the sludge. As a result, it is thought that in the comparative example, the sludge residence time lengthened, and matter such as biopolymers capable of accelerating blockages of the membrane tended to accumulate, resulting in a larger increase in the suction pressure per day. On the other hand, in the example and the like which implemented bypass inflow of the raw water, no marked increase in the suction pressure was observed. However, it is generally considered that as a result of predation between microorganisms and autolysis, an increase in sludge residence time causes a volume reduction, and therefore it is thought that consideration must be given to achieving the optimal sludge residence time. Based on the above results, it is evident that by implementing bypass inflow of the raw water into the activated sludge treatment tank, operations can be conducted with good suppression of both the elution of nitrogen and phosphorus into the treated water, and any increase in suction pressure of the separation membrane. Further, by adjusting the flow rate of the raw water being bypassed into the activated sludge treatment tank based on the nitrogen and/or phosphorus concentration of the treated water, without having to ascertain the soluble BOD sludge load, which can also be used to maintain a target water quality, elution of nitrogen and phosphorus into the treated water can be suppressed, and operations can be conducted with good maintenance of a favorable treated water quality, even if fluctuations in the raw water occur.

### REFERENCE SIGNS LIST

1: Raw water treatment device
10: Biological treatment tank
12: Membrane separation activated sludge treatment unit
14: Control device
16a to 16c: Pump
18: Nitrogen concentration detector
20: Phosphorus concentration detector
22a. 22b: Inflow line
24: Bypass line
26: Treated water discharge line
28: Sludge discharge line
30a. 30b: Flow rate adjustment valve
32: Activated sludge treatment tank
34: Membrane separation device
36: Carrier
38: Aeration device
40: Blower

1. A raw water treatment method comprising:
treating raw water using a raw water treatment device provided with a biological treatment tank containing a carrier supporting an aerobic microorganism, and a membrane separation activated sludge treatment unit comprising an activated sludge treatment tank containing an activated sludge into which first treated water that has undergone biological treatment in the biological treatment tank flows, and a membrane separation device that subjects second treated water that has undergone biological treatment in the activated sludge treatment tank to a membrane treatment, and
causing a portion of the raw water to bypass the biological treatment tank and flow into the activated sludge treatment tank, wherein
a flow rate of the raw water bypassing the biological treatment tank and flowing into the activated sludge treatment tank is controlled based on a nitrogen concentration and a phosphorus concentration in third treated water that has undergone treatment in the membrane separation device.

2. The water treatment method according to claim 1, further comprising:
adding a nitrogen source and/or a phosphorus source to the biological treatment tank, wherein
an amount of the nitrogen source and/or the phosphorus source to be added is controlled based on the flow rate of the raw water bypassing the biological treatment tank.

3. The water treatment method according to claim 1, further comprising: adding an inorganic coagulant to the activated sludge treatment tank in those cases where the phosphorus concentration in the third treated water that has undergone treatment in the membrane separation device equals or exceeds a prescribed value.

4. A raw water treatment device for treating raw water, the device having:
a biological treatment tank containing a carrier supporting an aerobic microorganism,
a membrane separation activated sludge treatment unit comprising an activated sludge treatment tank containing an activated sludge into which first treated water that has undergone biological treatment in the biological treatment tank flows, and a membrane separation device that subjects second treated water that has undergone biological treatment in the activated sludge treatment tank to a membrane treatment,
a bypass line that causes a portion of the raw water to bypass the biological treatment tank and flow into the activated sludge treatment tank, and
a control unit for controlling a flow rate of the raw water flowing through the bypass line based on a nitrogen concentration and a phosphorus concentration in a third treated water that has undergone treatment in the membrane separation device.

5. The water treatment device according to claim 4, also having:
a nitrogen source-phosphorus source addition unit for adding a nitrogen source and/or a phosphorus source to the biological treatment tank, wherein
the nitrogen source-phosphorus source addition unit controls an amount of the nitrogen source and/or the phosphorus source to be added based on the flow rate of the raw water flowing through the bypass line.

6. The water treatment device according to claim 4, also having:
an inorganic coagulant addition unit for adding an inorganic coagulant to the activated sludge treatment tank, wherein
the inorganic coagulant addition unit adds the inorganic coagulant to the activated sludge treatment tank in those cases where the phosphorus concentration in the third treated water that has undergone treatment in the membrane separation device equals or exceeds a prescribed value.
